(19) United States
(12) Patent Application Publication
(10) Pub. No.: US 2024/0325911 A1
(43) Pub. Date: Oct. 3, 2024

(54) INFORMATION PROMPTING METHOD AND APPARATUS, STORAGE MEDIUM, AND ELECTRONIC DEVICE

(71) Applicant: Tencent Technology (Shenzhen) Company Limited, Shenzhen (CN)

(72) Inventors: Ziyi WANG, Shenzhen (CN); Chenghao YE, Shenzhen (CN)

(21) Appl. No.: 18/739,177

(22) Filed: Jun. 10, 2024

Related U.S. Application Data
(63) Continuation of application No. PCT/CN2023/105464, filed on Jul. 3, 2023.

(30) Foreign Application Priority Data
Aug. 22, 2022 (CN) 202211009642.9

(51) Int. Cl. A63F 13/56; G06T 19/20

(52) U.S. Cl. CPC A63F 13/56; G06T 19/20; G06T 2219/2004

(57) ABSTRACT

This application discloses an information prompting method performed by an electronic device. The method includes: displaying a virtual scene, the virtual scene including a target virtual object, a first virtual character controlled by a first terminal and a second virtual character controlled by a second terminal; receiving a control operation for the first virtual character when a distance between the first virtual character and the target virtual object is less than a first preset threshold; in response to the control operation, triggering an interaction function corresponding to the target virtual object of the virtual scene; and in response to the interaction function, transmitting object prompting information associated with the target virtual object to the second terminal, the object prompting information prompting the second virtual character to interact with the target virtual object. This application resolves the technical problem of low efficiency of information prompting.

### CROSS-REFERENCE TO RELATED APPLICATIONS

This application is a continuation application of PCT Patent Application No. PCT/CN2023/105464, entitled “INFORMATION PROMPTING METHOD AND APPARATUS, STORAGE MEDIUM, AND ELECTRONIC DEVICE” filed on Jul. 3, 2023, which claims priority to Chinese Patent Application No. 202211009642.9, entitled “INFORMATION PROMPTING METHOD AND APPARATUS, STORAGE MEDIUM, AND ELECTRONIC DEVICE” filed on Aug. 22, 2022, all of which are incorporated by reference in their entirety.

### FIELD OF THE TECHNOLOGY

This application relates to the field of computers, and specifically, to an information prompting technology.

### BACKGROUND OF THE DISCLOSURE

With development of virtual games, there are more types of games. In some game scenes, a player needs to find out and pick up various materials, and uses these materials to complete game tasks. However, in a virtual game that needs cooperation of a plurality of players to complete, when it comes to a search scene of materials, a cooperative search of the materials can often be carried out through a cooperation of a plurality of players.

In general, after a player knows a material that a teammate needs, the player relies on memory to remember the material that the teammate needs and pays attention to. When there is the needed material, the teammate is informed of a location of the material, either by dictating a current location, or by using a marking function provided in the game to mark the material to the teammate, thereby prompting the teammate to obtain the material.

But the foregoing manner requires the player to remember and pay attention. This may distract a part of the player's energy, thereby affecting the player's gaming experience. In addition, the efficiency is also low to a certain extent, and after the material is found, it is necessary to prompt the teammate through complex operations, so that the prompting efficiency is low and is not conducive to the virtual game in the foregoing search scene. In other words, the foregoing manner has problems such as low prompting efficiency, and poor gaming experience.

### SUMMARY

Embodiments of this application provide an information prompting method and apparatus, a storage medium, and an electronic device, to resolve at least the technical problem of low information prompting efficiency.

According to an aspect of the embodiments of this application, an information prompting method is provided, performed by an electronic device, the method includes:

displaying a virtual scene, the virtual scene including a target virtual object, a first virtual character controlled by a first terminal and a second virtual character controlled by a second terminal;

receiving a control operation for the first virtual character when a distance between the first virtual character and the target virtual object is less than a first preset threshold;

in response to the control operation, triggering an interaction function corresponding to the target virtual object of the virtual scene; and

in response to the interaction function, transmitting object prompting information associated with the target virtual object to the second terminal, the object prompting information prompting the second virtual character to interact with the target virtual object.

According to still another aspect of the embodiments of this application, a non-transitory computer-readable storage medium is further provided. The computer-readable storage medium has a computer program stored thereon, and the computer program is configured to perform the foregoing information prompting method when being run by an electronic device.

According to still another aspect of the embodiments of this application, an electronic device is further provided. The electronic device includes a memory, a processor, and a computer program stored in the memory and capable of being run on the processor. The processor performs the foregoing information prompting method by using the computer program.

In the embodiments of this application, the method includes: displaying at least a part of a virtual scene, the virtual scene including a first virtual character and a second virtual character; receiving a control operation for the first virtual character, and triggering, through the control operation, an interaction function corresponding to a target virtual object of the virtual scene; and generating object prompting information in response to the interaction function, the object prompting information being configured for prompting the second virtual character to interact with the target virtual object. The virtual character manually marking a material is transformed to a system automatically triggering, according to a control operation of the player, the marked object, so that the need for a player to manually mark and remember the object location is eliminated, an operational requirement of the player is lowered, transmission of information in the team is accelerated, and a search process for materials in the game is facilitated, thereby achieving the technical effect of improving information prompting efficiency, and resolving the technical problem of low information prompting efficiency.

### BRIEF DESCRIPTION OF THE DRAWINGS

The accompanying drawings described herein are used to provide a further understanding of this application, and form a part of this application. Exemplary embodiments of this application and descriptions thereof are used to explain this application, and do not constitute any inappropriate limitation to this application. In the accompanying drawings:

FIG. 1 is a schematic diagram of an application environment of an exemplary information prompting method according to an embodiment of this application.

FIG. 2 is a schematic flowchart of an exemplary information prompting method according to an embodiment of this application.

FIG. 3 is a schematic diagram of an exemplary information prompting method according to an embodiment of this application.

FIG. 4 is a schematic diagram of another exemplary information prompting method according to an embodiment of this application.

FIG. 5 is a schematic diagram of another exemplary information prompting method according to an embodiment of this application.

FIG. 6 is a schematic diagram of another exemplary information prompting method according to an embodiment of this application.

FIG. 7 is a schematic diagram of another exemplary information prompting method according to an embodiment of this application.

FIG. 8 is a schematic diagram of another exemplary information prompting method according to an embodiment of this application.

FIG. 9 is a schematic diagram of another exemplary information prompting method according to an embodiment of this application.

FIG. 10 is a schematic diagram of another exemplary information prompting method according to an embodiment of this application.

FIG. 11 is a schematic diagram of another exemplary information prompting method according to an embodiment of this application.

FIG. 12 is a schematic diagram of another exemplary information prompting method according to an embodiment of this application.

FIG. 13 is a schematic diagram of another exemplary information prompting method according to an embodiment of this application.

FIG. 14 is a schematic diagram of another exemplary information prompting method according to an embodiment of this application.

FIG. 15 is a schematic diagram of another exemplary information prompting method according to an embodiment of this application.

FIG. 16 is a schematic diagram of another exemplary information prompting method according to an embodiment of this application.

FIG. 17 is a schematic diagram of another exemplary information prompting method according to an embodiment of this application.

FIG. 18 is a schematic diagram of another exemplary information prompting method according to an embodiment of this application.

FIG. 19 is a schematic diagram of an information prompting apparatus according to an embodiment of this application.

FIG. 20 is a schematic diagram of a structure of an optional electronic device according to an embodiment of this application.

### DESCRIPTION OF EMBODIMENTS

In order to make a person skilled in the art better understand the solutions of this application, the following clearly and completely describes the technical solutions in the embodiments of this application with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall in the protection scope of this application.

In this application, claims, and the foregoing accompanying drawings of the present disclosure, the terms “first”, “second”, and the like are intended to distinguish between similar objects but do not necessarily indicating a specific order or sequence. Such used data is changeable under appropriate conditions, so that the embodiments of this application described here can be implemented in an order other than those illustrated or described here. Moreover, the terms “include”, “have” and any other variants are intended to cover the non-exclusive inclusion, for example, a process, method, system, product, or device that includes a list of operations or units is not necessarily limited to those expressly listed operations or units, but may include other operations or units not expressly listed or inherent to such a process, method, system, product, or device.

The solutions provided in the embodiments of this application involve technologies, such as a computer vision technology, which are described in detail in the following embodiments:

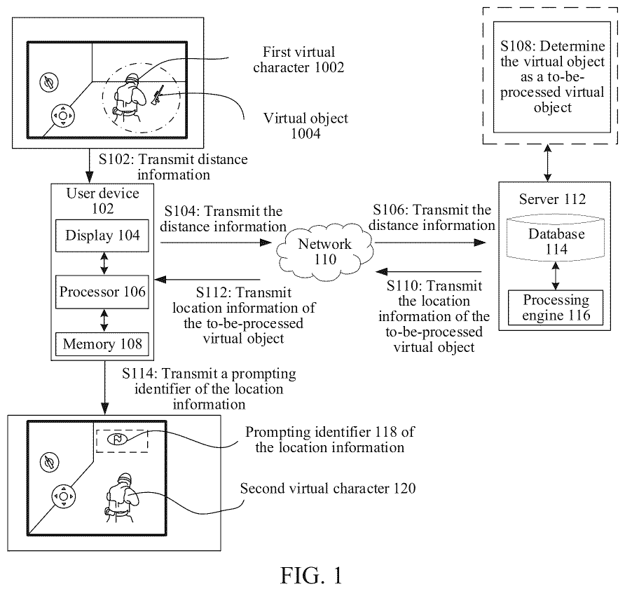

According to an aspect of the embodiments of this application, an information prompting method is provided. As an optional implementation, the foregoing information prompting method may be, but is not limited to, applied in an environment shown in FIG. 1. The environment may include, but is not limited to, a user device 102 and a server 112. The user device 102 may include but is not limited to a display 104, a processor 106, and a memory 108. The server 112 includes a database 114 and a processing engine 116.

Specific processes are as follows:

S102: The user device 102 obtains distance information of a virtual object 1004 from a client corresponding to a first virtual character 1002.

S104 to S106: The obtained distance information of the virtual object 1004 is transmitted to the server 112 over a network 110.

S108: The server 112 determines a target virtual object by using the processing engine 116, and further obtains location information of the target virtual object.

S110 to S112: The location information of the target virtual object is transmitted to the user device 102 over the network 110, the user device 102 determines, by using the processor 106, a corresponding prompting identifier 118 by using the location information, displays the prompting identifier on the display 108, and stores the foregoing location information into the memory 104.

S114: The user device 102 transmits the prompting identifier 118 of the location information to a client corresponding to a second virtual character 120.

In addition to the example shown in FIG. 1, the foregoing operations may be implemented by a client or a server independently, or implemented by the client and the server coordinately. In other words, the electronic device for implementing the method provided in this embodiment of this application may be the client and/or the server. For example, the user device 102 performs the foregoing operations such as S108, thereby reducing processing pressure of the server 112. The user device 102 includes but is not limited to a handheld device (such as a mobile phone), a laptop, a desktop computer, an on-board device, and the like. The specific implementations of the user device 102 are not limited in this application.

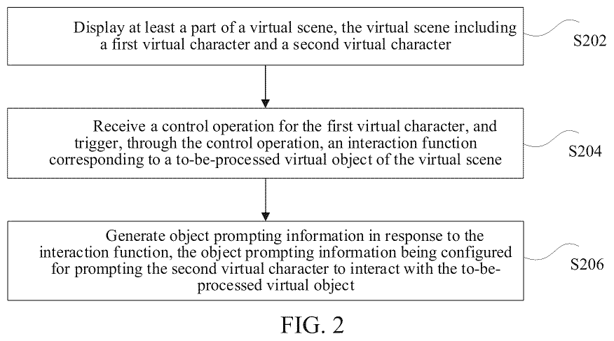

As an optional implementation, as shown in FIG. 2, the information prompting method includes:

S202: Display at least a part of a virtual scene, the virtual scene including a first virtual character and a second virtual character.

S204: Receive a control operation for the first virtual character, and triggering, through the control operation, an interaction function corresponding to a target virtual object of the virtual scene.

S206: Generate object prompting information in response to the interaction function, the object prompting information being configured for prompting the second virtual character to interact with the target virtual object.

In a possible implementation, in this embodiment, the foregoing information prompting method may be, but is not limited to, applied in a shooting game scene. A shooting game application may be a third person shooting game (short for TPS) application, such as running the shooting game application from a viewing angle of a third-party character object other than a virtual character controlled by a current player. The shooting game application may alternatively be a first person shooting game (short for FPS) application, such as running the shooting game application from a viewing angle of the virtual character controlled by the current player. In current games, when players form a team to play the game, every time the team helps another player find a needed material, the team needs to rely on memory to remember the needed material of other teammates. When there is the needed material, there is a need to have a certain amount of dedication, that is, spend a certain amount of time and energy to inform the teammates of a material mark to help the teammates obtain the material. However, the manner that requires the player to manually trigger distracts the player's energy and affects the player's action efficiency, thereby causing low willingness of teammates to help each other find materials in team games, and low interaction efficiency among the teammates in the team. The embodiment uses an automated execution method, so that the player does not need to perform additional operations, and only needs to satisfy a condition of the control operation to implement the operation of helping the teammates find materials. The control operation is an action that a player needs to perform in a shooting game scene, the player does not need a certain dedication operation, and only needs a normal control operation to automatically help the teammates, without additional energy. This improves efficiency of equipment and prop accumulation in the team, and enhances team game experience.

In a possible implementation, what is displayed in S202 may be an entire virtual scene, or may be a part of the virtual scene rather than the entire virtual scene. The virtual scene may include a first virtual character and a second virtual character. Two virtual characters may be, but are not limited to, displayed at the same time. Alternatively, the first virtual character or the second virtual character may be displayed.

In a possible implementation, in this embodiment, the first virtual character in S202 may be, but is not limited to, a virtual character controlled by a player in a virtual scene, and the second virtual character may be, but is not limited to, another virtual character controlled by the player in the virtual scene. The first virtual character and the second virtual character are different virtual characters.

When the virtual scene is a virtual scene for a battle game, virtual characters in the virtual scene may be divided into at least two camps. In general, if a player is willing to help another player find virtual objects (such as materials), then the two players are usually teammates. Correspondingly, the first virtual character and the second virtual character corresponding to the two players are in the same camp.

In a possible implementation, when a game is started, a virtual scene in which the first virtual character and the second virtual character are located may be displayed on any client participating in the game. In this embodiment of this application, if clients participating in the game corresponds to the first virtual character and the second virtual character separately, the foregoing virtual scene may be displayed on a client corresponding to the first virtual character, or a client corresponding to the second virtual character. The client of the foregoing virtual scene is not limited in the embodiments of this application.

In a possible implementation, in this embodiment, the control operation in S204 may be, but is not limited to, a control operation that the player needs to perform. For example, a movement operation, the movement operation is an operation that the player needs to perform in the game to control a movement of the virtual character. For example, a virtual character movement can be walking, running, crawling, and the like. The target virtual object may be a virtual object that the second virtual character needs to interact with, may be but is not limited to commonly used or hidden materials in the game, and may include, but is not limited to, a vehicle, an attack prop, a treatment prop, an attachment on a prop, a non-player character (NPC), and the like. The interaction function may be a function of interacting with a to-be-processed object. The interaction function may mainly refer to a sharing function. The embodiments of this application also mainly introduce the sharing function as an example. Certainly, the interaction function may also refer to another function that interacts with the to-be-processed object. This is not limited in the embodiments of this application. The sharing function may include, but is not limited to, a material being allowed to be shared and a game-given material being allowed to be shared. For example, the material has a certain area of halo. When the first virtual character triggers the halo through a control operation, material information is directly shared with the second virtual character. This automatic sharing function is only related to the material. In addition, for example, the material can be a treasure box. The first virtual character needs to move to the treasure box and open the treasure box, then the treasure box can be shared with the second virtual character. The sharing function is given by the game to the material, and the function can be shared only when a preset condition is satisfied. The object prompting information is configured for prompting the second virtual character to obtain the target virtual object. The object prompting information may be displayed, but is not limited to, in a manner of a mini map, a location mark, footprint, and the like, and may include, but is not limited to, display location information, a damage status, a skin level, and the like of the target virtual object.

In S206, the object prompting information is configured for prompting the second virtual character to interact with the target virtual object. The interaction here may be any operation that the second virtual character performs on the target virtual object. For example, the interaction may be that the target virtual object is obtained, the target virtual object is used, the target virtual object is given to other virtual characters, and the like. What kind of interaction that the second virtual character interacts with the target virtual object is not limited in the embodiments of this application.

After the object prompting information is generated, to enable a player corresponding to the second virtual character to watch the object prompting information, thereby interacting with the target virtual object to display the object prompting information.

In the embodiments of this application, an example in which the first virtual character triggers the interaction function through the control operation to help the second virtual character to obtain the target virtual object is used, to facilitate the second virtual character to interact with the target virtual object in time, a manner of displaying the object prompting information may be that the client corresponding to the second virtual character displays the object prompting information. In addition, another client participating in a game may also display the object prompting information.

The control operation is an operation that a player needs to perform in various games. In some cases, these control operations can trigger a sharing function for the target virtual object, thereby directly displaying the object prompting information to prompt the second virtual character to interact with the target virtual object. Because the control operation is a necessary operation for the player to control the virtual character in the game, there is no other additional operations introduced, and the object prompting information can be displayed directly after the sharing function is triggered, without a manual operation by the player, so that this application implements the automatic interaction function. The method of marking materials provided in related technologies requires active and manual operations by the player who finds the materials to trigger sharing of the location of the materials with other teammates in the team. This embodiment takes into account that the foregoing method of marking materials has a certain operational requirement. A new player needs to understand the operation manner in advance to trigger the marking of the materials. However, this embodiment only requires the player to complete the sharing of the materials through the control operation, that is, through random and simple control, thereby bringing benefits to teammates, lowering the operational requirement, and improving the fault tolerance rate of the game.

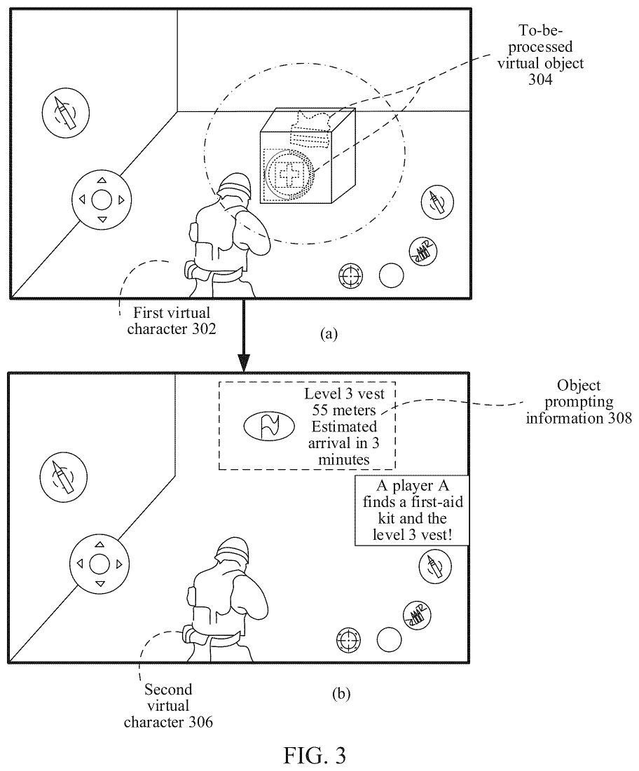

To further describe, for example, as shown in section (a) of FIG. 3, the first virtual character 302 moves to an airdrop location. In this case, a center of gravity of the airdrop is a center of a circle, showing a halo in a circular area. When the first virtual character 302 moves into the airdrop halo, an automatic interaction function corresponding to the target virtual object 304 including a medical package and a level 3 vest in a virtual scene is automatically triggered, for example, as shown in section (b) of FIG. 3, the object prompting information 308 is displayed on the client corresponding to the second virtual character 306.

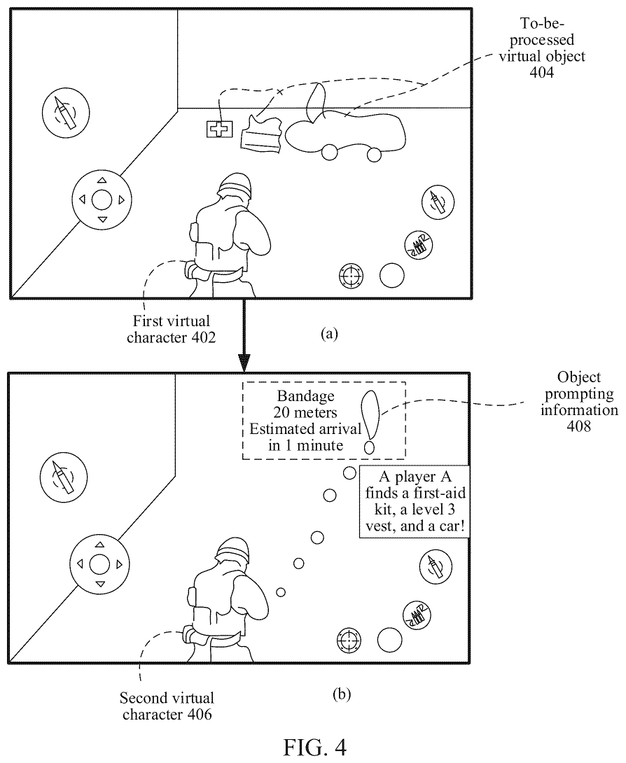

To further describe, for example, as shown in section (a) of FIG. 4, the first virtual character 402 moves to a location of a specific virtual scene and finds that there are target virtual objects 404 such as a bandage, a level 2 vest, and a car in the virtual scene. The automatic interaction functions of the foregoing target virtual objects in the virtual scene are automatically triggered, for example, as shown in section (b) in FIG. 4, and the object prompting information 408 on the client corresponding to the second virtual character 406 is displayed.

In a possible implementation, in this embodiment, after the first virtual character triggers, through the control operation, the automatic interaction function corresponding to the target virtual object in the virtual scene, information such as location information, a damage status, a skin level, and the like may be displayed in, but is not limited to, clients corresponding to a plurality of virtual characters. If the second virtual character interacts with the target virtual object being that the second virtual character obtains the target virtual object, when the second virtual character arrives at a location of the target virtual object and obtains a part of the target virtual object, a status of the target virtual object is updated to other virtual character objects. The status of the target virtual object may include, but is not limited to, information of remaining target virtual objects, information corresponding to obtained target virtual objects, and a nickname of the virtual character of the target virtual object.

In a possible implementation, in this embodiment, after the first virtual character triggers, through the control operation, the automatic interaction function corresponding to the target virtual object in the virtual scene, data such as location information data, damage status data, skin level data of the target virtual object may be stored by, but is not limited to, creating a virtual memory. After the second virtual character arrives at the location of the target virtual object and obtains a part of the target virtual object, the data of the target virtual object is updated in the virtual memory, and the updated data is fed back to other virtual characters. When the target virtual objects are obtained, the virtual memory is released and the information that the target virtual objects are obtained is fed back to other virtual characters.

The embodiment takes into account that when the plurality of players form a team to play the game, after the first virtual character triggers the automatic interaction function, both the second virtual character and a third virtual character have an opportunity to arrive at the location of the target virtual object according to the location information and obtain the target virtual object. When the third virtual character arrives at the location first and interacts with the target virtual object, because the second virtual character does not know that the third virtual character interacts with the target virtual object, the second virtual character continues to go to the location of the virtual object. In the view of this, to avoid the foregoing situation, which may waste time and energy of the second virtual character, casily promote competition between players in the same camp, and reduce team game experience, this embodiment adds a virtual cache to a computer program. When the virtual character obtains the target virtual object, the information is updated to other virtual characters, so that a competition between players in the same camp is avoided, the relationship between teammates is intimate in the team game, the difference between the team game and a single game is increased, and group experience of the team game is improved.

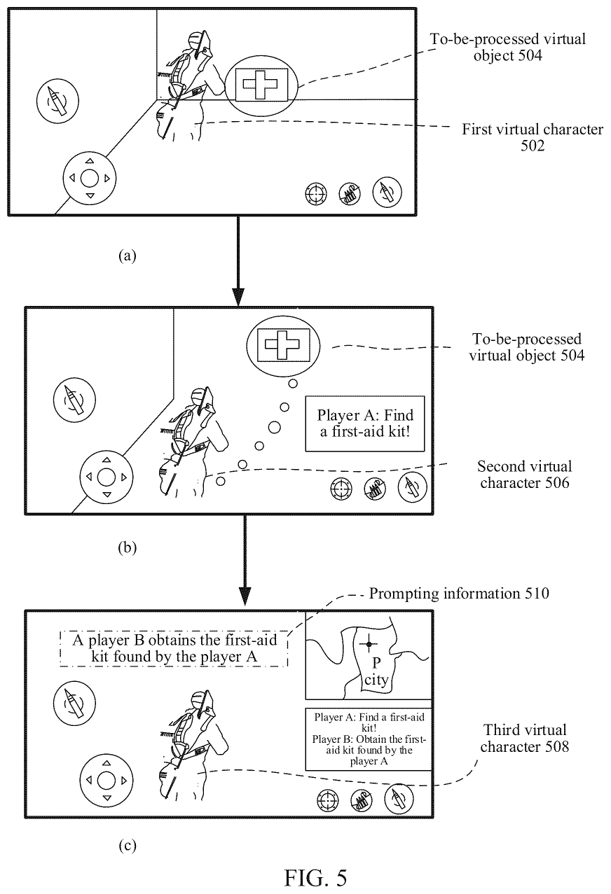

To further describe, for example, an example in which the interaction function is a sharing function, and the second virtual character interacts with the target virtual object to obtain the target virtual object for the second virtual character is used. For example, as shown in section (a) of FIG. 5, after the first virtual character 502 triggers, through the control operation, the automatic sharing function corresponding to the target virtual object 504 in the virtual scene, location information of a first-aid kit (that is, the target virtual object) is displayed in clients of the second virtual character 506 and the third virtual character 508 separately. For example, as shown in section (b) of FIG. 5, when the second virtual character 506 arrives at the location information and obtains the first-aid kit, in this case, the information that the first-aid kit is obtained by the second virtual character 506 is updated in a client of the third virtual character 508, and prompting information 510 corresponding to names of the obtained target virtual object 504 and the obtained to-be-processed second virtual character 506 is displayed in the client of the third virtual character 508, as shown in section (c) of FIG. 5.

In a possible implementation, in this embodiment, when the second virtual character arrives at the location of the target virtual object according to the automatic sharing function triggered by the first virtual character, and obtains the target virtual object, a virtual interaction identifier such as a heart, text of “Thanks for sharing”, an expression may be, but is not limited to, fed back to the first virtual character. This is not limited herein.

In this embodiment, after the second virtual character interacts with the target virtual object shared by the first virtual character, interactions between the first virtual character and the second virtual character are increased. The first virtual character is enabled to know that the second virtual character interacts with the target virtual object. In addition, an interaction relationship between teammates in the team game is close, thereby improving interaction efficiency in the team game, and bringing friendly interaction experience to players.

To further describe, for example, an example in which the interaction function is a sharing function, and the second virtual character interacts with the target virtual object to obtain the target virtual object for the second virtual character is used. For example, as shown in FIG. 6, the first virtual character 602 automatically shares the target virtual object with the second virtual character B through the control operation. When the second virtual character B arrives at a level 3 helmet (that is, to-be-processed virtual character) and obtains the level 3 helmet, text prompting information 604 “Thanks for the level 3 helmet” is displayed in a client of the first virtual character 602, and a virtual interaction identifier 606 of a heart shape is displayed on a display screen.

Through the embodiments provided in this application, at least a part of a virtual scene is displayed, and the virtual scene includes a first virtual character and a second virtual character. A control operation for the first virtual character is received, and an interaction function corresponding to a target virtual object of the virtual scene is triggered through the control operation. Object prompting information is generated in response to the interaction function, and the object prompting information is configured for prompting the second virtual character to interact with the target virtual object. The virtual character manually marking a material is transformed to a system automatically triggering, according to a control operation of the user, the marked object, so that the need for a player to manually mark and remember the object location is eliminated, an operational requirement of the player is lowered, transmission of information in the team is accelerated, and a search process for materials in the game is facilitated, thereby achieving the technical effect of improving information prompting efficiency.

As an exemplary solution, the displaying object prompting information includes:

displaying location information of the target virtual object in the virtual scene, the location information of the target virtual object in the virtual scene being the object prompting information.

In a possible implementation, in this embodiment, the location information may include, but is not limited to, a straight line distance between the virtual character and the target virtual object, a coordinate of the target virtual object displayed in the mini map, an optimal route between the virtual character and the target virtual object, time for the virtual character to arrive at the location of the target virtual object. The location information may be, but is not limited to, the optimal route and time required for the virtual character to arrive at the location of the target virtual object calculated using a neural network algorithm.

In the embodiments of this application, the second virtual character may determine the location of the target virtual object based on the location information, thereby eliminating the need for the first virtual character to dictate the location or manually mark the location, to achieve the automatic sharing function.

According to the embodiments of this application, the location information of the target virtual object in the virtual scene is displayed, to prompt the second virtual character how to obtain the target virtual object, thereby achieving the technical effect of improving display efficiency and integrity of the target virtual object.

The location information of the target virtual object in the virtual scene may be displayed on any client participating in the game. As an exemplary solution, a manner of displaying the location information of the target virtual object in the virtual scene may be that a client corresponding to the second virtual character displays the location information of the target virtual object in the virtual scene.

As an option solution, the displaying, on a client corresponding to the second virtual character, the location information of the target virtual object in the virtual scene includes at least one of the following:

S1: Mark and display, on a mini map interface, the location information of the target virtual object in the virtual scene if the client corresponding to the second virtual character displays the mini map interface. The mini map interface is configured for thumbnail displaying scene content of the virtual scene.

S2: Display guidance information in a viewing angle picture if the client corresponding to the second virtual character displays the viewing angle picture corresponding to the second virtual character. The guidance information is configured for guiding the second virtual character to move to a location of the target virtual object in the virtual scene.

S3: If the client corresponding to the second virtual character displays the viewing angle picture, and the viewing angle picture displays the target virtual object, display, in the viewing angle picture, a prompting identifier corresponding to the target virtual object. The prompting identifier is configured for prompting a location of the target virtual object.

A plurality of display methods are determined based on different distances or customized display location information. This improves diversity of display methods and improves display efficiency, to enable the player to quickly and clearly obtain the location of the target virtual object.

In a possible implementation, in this embodiment, the mini map interface may be, but is not limited to, a map configured to be a map at a display corner of the client corresponding to the virtual character to assist the player in determining the location of the virtual character. The guidance information may, but is not limited to, guide, through auxiliary displays including footprints, arrows, flags, and the like, the second virtual character to move to the location of the target virtual object. There are many manners of displaying the prompting identifier, for example, the prompting identifier may be highlighted. The highlighted display may include, but is not limited to, a halo sound prompt and other display manners. The prompting identifier is configured for prompting the location of the target virtual object.

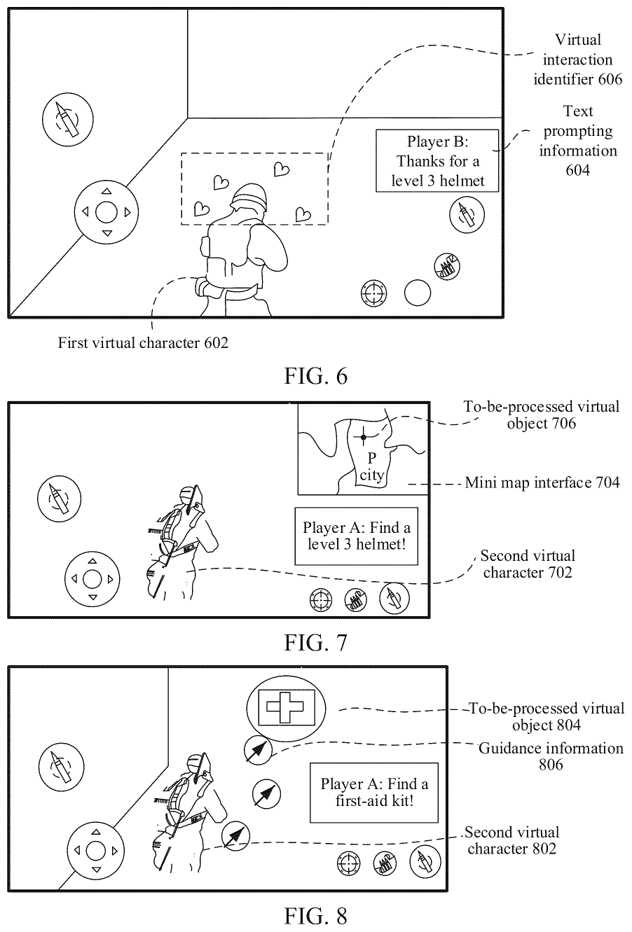

To further describe, for example, as shown in FIG. 7, it is detected that the first virtual character moves to the first-aid kit (that is, the target virtual object), and triggers the automatic sharing function to share the location of the foregoing target virtual object with another virtual character in the same camp. The second virtual character 702 is far away from the target virtual object 706, and the location information of the target virtual object 706 in the virtual scene is marked and displayed on the mini map interface 704.

To further describe, for example, as shown in FIG. 8, it is detected that the virtual character A moves to the first-aid kit, the level 3 helmet, the level 3 vest (that are, the target virtual objects), and triggers the automatic sharing function to share the locations of the target virtual objects with other virtual characters in the same camp. The second virtual character 802 is close to the target virtual object 804, and the guidance information 806 is displayed in the viewing angle picture through footprints or arrows.

To further describe, for example, as shown in FIG. 9, it is detected that the virtual character A moves to the first-aid kit, the level 3 helmet, the level 3 vest, and triggers the automatic sharing function to share the locations of the target virtual objects with other virtual characters in the same camp. When the target virtual object 904 is in the viewing angle picture corresponding to the client of the virtual character 902, the prompting identifier 906 corresponding to the target virtual object is highlighted in the viewing angle picture.

In a possible implementation, in this embodiment, a first distance threshold and a second distance threshold can be set but is not limited to, different display manners are determined according to different distance thresholds. The first distance threshold and the second distance threshold may be, but are not limited to, be determined according to a distance between the virtual character and the target virtual object. If a distance between the virtual character and the target virtual object is greater than the first distance threshold, a mini map mark display method is used. If the distance between the virtual character and the target virtual object is less than the first distance threshold and greater than the second distance threshold, a guidance information display method is used. If the distance between the virtual character and the target virtual object is less than the second distance threshold, a highlighted display method is used.

According to the embodiments provided in this application, the location information of the target virtual object in the virtual scene is marked and displayed, when the client corresponding to the second virtual character displays the mini map interface, on a mini map interface. The mini map interface is configured for thumbnail displaying scene content of the virtual scene. Guidance information is displayed in a viewing angle picture if the client corresponding to the second virtual character displays the viewing angle picture corresponding to the second virtual character. The guidance information is configured for guiding the second virtual character to move to a location of the target virtual object in the virtual scene. If the client corresponding to the second virtual character displays the viewing angle picture, and the viewing angle picture displays the target virtual object, a prompting identifier corresponding to the target virtual object is displayed in the viewing angle picture. The prompting identifier is configured for prompting a location of the target virtual object, to display the location information through a plurality of display manners, thereby achieving the technical effect of improving diversity of display methods.

As an exemplary solution, before the generating object prompting information, the method further includes:

S1: Display virtual identifiers of candidate virtual objects in a plurality of candidate virtual objects.

S2: Determine a target virtual identifier from the virtual identifiers of the candidate virtual objects.

S3: Determine a candidate virtual object corresponding to the target virtual identifier as the target virtual object.

In a possible implementation, in this embodiment, the virtual identifier may include, but is not limited to, an identifier corresponding to the candidate virtual object, and may include, but is not limited to, an appearance characteristic and a basic attribute of the candidate virtual object. The target virtual identifier is an identifier finally displayed in the client of the second virtual character determined from the plurality of candidate virtual objects. The candidate virtual objects may be, but are not limited to, a plurality of virtual objects shared by the second virtual character when the first virtual character triggers the automatic sharing function through the control operation.

In the related art, players need to manually operate to share the location information of the target virtual object with other teammates. Therefore, when a plurality of virtual objects are stacked together, it is difficult to distinguish the target virtual objects. The embodiments of this application overcome a high operational requirement of manual operation through the automatic sharing function, and determines the target virtual object based on quality, effect, rarity, and the like of the virtual object when a plurality of candidate virtual objects appear, to improve display efficiency of the target virtual identifier.

To further describe, for example, the virtual character A moves to a game scene, and finds a plurality of candidate objects, that are, a level 1 helmet, a level 2 helmet, a level 3 helmet. A virtual identifier corresponding to the level 3 helmet is determined as the target virtual identifier according to quality of effect of the virtual object, and location information corresponding to the level 3 helmet is shared with the second virtual character.

According to the embodiments provided in this application, virtual identifiers of candidate virtual objects in a plurality of candidate virtual objects are displayed. A target virtual identifier is determined from the virtual identifiers of the candidate virtual objects. A candidate virtual object corresponding to the target virtual identifier is determined as the target virtual object, to determine the target virtual object from the plurality of to-be-obtained virtual objects, thereby achieving the technical effect of improving display efficiency of the virtual identifier.

As an exemplary solution, the displaying virtual identifiers of candidate virtual objects in a plurality of candidate virtual objects includes at least one of the following:

S1: Display a virtual identifier of a virtual object not interacted with the second virtual character. Each candidate virtual object includes the non-interacted virtual object.

S2: Display a virtual identifier corresponding to a to-be-processed attachment object. The to-be-processed attachment object is an attachment object that is not configured by a virtual primary object interacted with the second virtual character, and the candidate virtual object includes the to-be-processed attachment object.

S3: Display a virtual identifier corresponding to a virtual object that the second virtual character allows to interact with. The candidate virtual object includes the virtual object that allows to interact with.

S4: Display a virtual identifier corresponding to a virtual object pre-configured for the second virtual character. The candidate virtual object includes the virtual object pre-configured for the second virtual character.

In a possible implementation, in this embodiment, the attachment object may be a part or component needed to be configured on the virtual primary object, for example, a multi-times scope, a stock, a flash hider, a grip. The virtual primary object may be, but is not limited to, a target virtual object allowed to be configured with the part and component.

In a possible implementation, in this embodiment, a virtual identifier of a virtual object not interacted with the second virtual character is displayed. A virtual object owned by the second virtual character is obtained from the plurality of candidate virtual objects. The owned virtual object is compared with the candidate virtual object to determine a virtual object not owned by the second virtual character, and the virtual identifier of the foregoing virtual object is displayed in the client corresponding to the second virtual character.

In a possible implementation, in this embodiment, the virtual primary object owned by the second virtual character and the attachment object configured in the virtual primary object are obtained. The candidate virtual object is compared with the attachment object configured in the virtual primary object, to determine an attachment object (that is, the to-be-processed attachment object) not configured in the virtual primary object in the second virtual character, and the virtual identifier of the foregoing to-be-processed attachment object is displayed in the client corresponding to the second virtual character.

By dividing virtual objects into a virtual primary object and an attachment object, when the second virtual character owns the virtual primary object, the attachment object corresponding to the virtual primary object is first determined as the to-be-processed attachment object. The complexity of the virtual object is considered, so that accuracy of determining the target virtual object is improved.

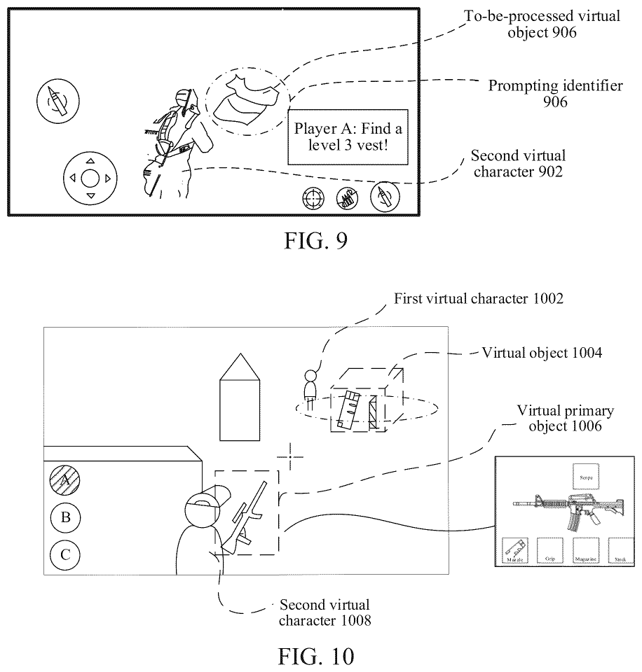

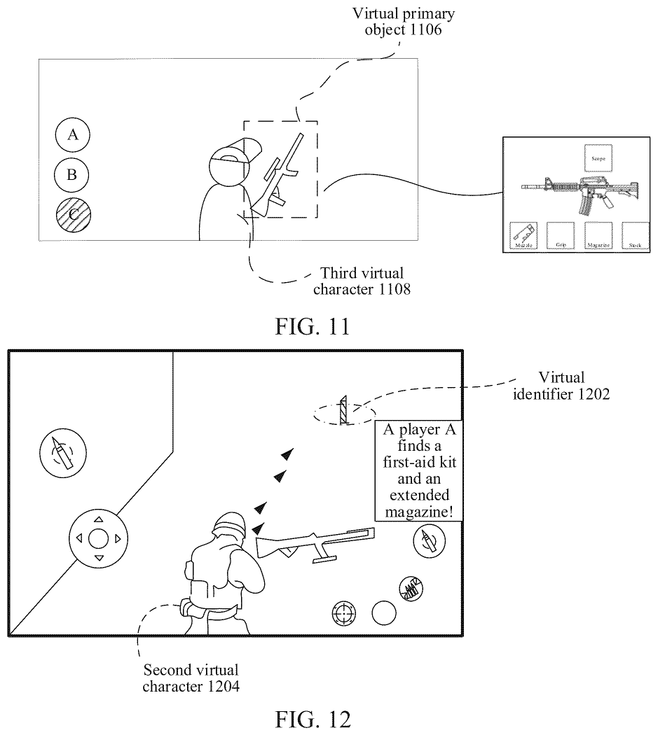

To further describe, for example, as shown in FIG. 10, the first virtual character 1002 moves in an aperture area displayed in airdrop, and the airdrop has an extended magazine and a muzzle of the virtual object 1004. The virtual primary object 1006 owned by the second virtual character 1008 is configured with the muzzle, but is not configured with the extended magazine, then it is determined that the extended magazine is the to-be-processed attachment object. For example, as shown in FIG. 11, the virtual primary object 1106 owned by the third virtual character 1108 has a muzzle and an extended magazine, so that the virtual identifier and prompting information are not displayed in a client of the third virtual object 1108. For example, as shown in FIG. 12, the virtual identifier 1202 of the extended magazine is displayed in the client of the second virtual character 1204.

In a possible implementation, in this embodiment, in-game game information of the second virtual character is obtained, and the virtual object that the second virtual character is allowed to interact with and the virtual object that the second virtual character is not allowed to interact with are determined. The candidate virtual object is compared with the virtual object that is not allowed to interact with, in this case, a virtual identifier corresponding to the virtual object that is not allowed to interact with is hidden, and the virtual identifier corresponding to the virtual object that is allowed to interact with among the candidate virtual objects is displayed.

In a possible implementation, in this embodiment, it may include, but is not limited to, that the second virtual character is pre-configured with virtual objects required or commonly used in a game. By triggering controls such as shortcut keys or shortcut acquisition, the client of the second virtual character compares the pre-configured virtual object with the candidate virtual object, and displays the virtual identifier corresponding to the pre-configured virtual object in the candidate virtual object.

According to the embodiments provided in this application, a virtual identifier of a virtual object not interacted with the second virtual character is displayed. A virtual identifier corresponding to the to-be-processed attachment object is displayed. A virtual identifier corresponding to a virtual object that the second virtual character allows to interact with is displayed. A virtual identifier corresponding to the virtual object pre-configured for the second virtual character is displayed, to determine the target virtual object through pre-configuration or the shortcut keys, thereby achieving the technical effect of improving flexibility of the player in interacting with the target virtual object.

As an exemplary solution, before the generating object prompting information, the method further includes at least one of the following:

S1: Display first text information, the first text information including object text information corresponding to a first candidate virtual object in the plurality of candidate virtual objects, and determine the first candidate virtual object as the target virtual object if the first text information indicates that the second virtual character interacts with the first candidate virtual object.

S2: Perform, when to-be-processed audio is obtained, audio recognition on the to-be-processed audio to obtain second text information, the second text information including object text information corresponding to a second candidate virtual object in the plurality of candidate virtual objects; and determine the second candidate virtual object as the target virtual object if the second text information indicates that the second virtual character interacts with the second candidate virtual object.

In a possible implementation, in this embodiment, the first candidate virtual object is a candidate virtual object corresponding to the first text information in the plurality of candidate virtual objects, and the second candidate virtual object is a candidate virtual object corresponding to the second text information in the plurality of candidate virtual objects.

The first text information may be, but is not limited to, text information that includes the candidate virtual object and that is input by the second virtual object through text. The second text information may be, but is not limited to, text information that includes the candidate virtual object and that is recognized through client voice recognition of the virtual object.

Through a combination of text and voice, the player can directly determine a desired virtual object through voice, thereby improving efficiency of determining the target virtual object.

To further describe, for example, when the virtual character A performs voice communication with other virtual characters in the same camp, and when other virtual characters in the same camp find candidate virtual objects including a four times scope, a bandages, and the like, if the client recognizes that audio information transmitted by the character A is “I need a four times scope”, the information can be converted into second text information. The candidate virtual object of the four times scope is included in the second text information, the candidate virtual object of the four times scope is determined as the second candidate virtual object, and the second candidate virtual object is determined as the target virtual object.

According to the embodiments of this application, first text information is displayed. The first text information includes object text information corresponding to a first candidate virtual object in the plurality of candidate virtual objects. The first candidate virtual object is determined as the target virtual object if the first text information indicates that the second virtual character interacts with the first candidate virtual object. When to-be-processed audio is obtained, audio recognition is performed on the to-be-processed audio to obtain second text information. The second text information includes object text information corresponding to a second candidate virtual object in the plurality of candidate virtual objects. The second candidate virtual object is determined as the target virtual object if the second text information indicates that the second virtual character interacts with the second candidate virtual object, to save typing time and energy of the player, thereby achieving the technical effect of improving operation efficiency of the player.

This application mainly triggers, through the control operation of the first virtual character, the interaction function corresponding to the target virtual object. The control operation is an operation that players need to perform in various games. In general, there may be many operations that a player needs to perform in a game. For example, an operation of controlling movement of the virtual character or an operation of controlling the virtual character to discard the virtual object. According to different control operations, the manner of triggering the interaction function corresponding to the target virtual object may also be different. As an exemplary solution, after the displaying at least a part of a virtual scene, the method further includes:

S1: Determine the target virtual object from at least one virtual object if a distance between the first virtual character and the at least one virtual object in the virtual scene is less than or equal to a first preset threshold.

The triggering, through the control operation, an interaction function corresponding to a target virtual object of the virtual scene includes:

S2: Trigger the interaction function if a distance between the moved first virtual character and the target virtual object is greater than a second preset threshold. The second preset threshold is greater than or equal to the first preset threshold.

In a possible implementation, in this embodiment, the first preset threshold may be, but is not limited to, a closer distance between the first virtual character and the virtual object, and the second preset threshold may be, but is not limited to, a farther distance between the first virtual character and the virtual object value. In this embodiment, the electronic device determines whether to trigger the interaction function based on the distance between the first virtual character and the target virtual object. If the distance between the first virtual character and the target virtual object is greater than the second preset threshold, the interaction function can be automatically triggered. In this way, a player corresponding to the first virtual character does not need to remember the target virtual object, and only needs to perform a normal control operation on the first virtual character. Therefore, the interaction function is an automatic interaction function.

Taking the interaction function as a sharing function as an example, in this embodiment, the first virtual character is set as a sharer and the second virtual character is set as a demander. When both two conditions that the sharer does not need and the demander needs are satisfied, it is determined to trigger the automatic sharing function. The target virtual object is displayed in the client of the second virtual object, a corresponding character is set, and then conditions required by different characters to achieve two opposite dimensions are combined, thereby avoiding an embarrassing situation of marking the virtual object needed by a finder to teammates, and improving the completeness and balance of the automatic sharing function.

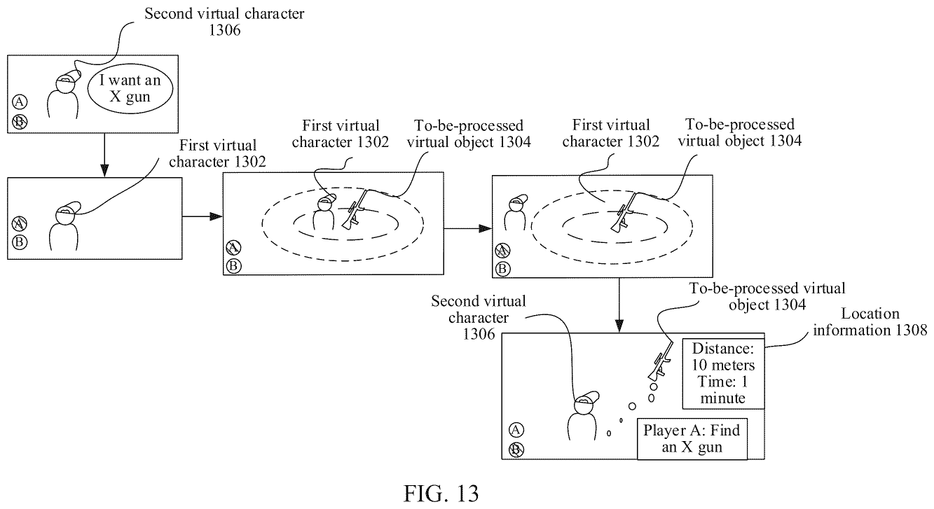

To further describe, for example, an example in which the interaction function is a sharing function, and the second virtual character interacts with the target virtual object to obtain the target virtual object for the second virtual character is used. For example, as shown in FIG. 13, the second virtual character 1306 transmits demand information “I want an X gun” to the client of the first virtual character 1302. When a distance between the first virtual character 1302 and the target virtual object 1304 is less than the first preset threshold, it means that the target virtual object 1304 is found, and the client of the first virtual character 1302 waits for the first virtual character 1302 to obtain the target virtual object 1304. When the distance between the first virtual character 1302 and the target virtual object 1304 is greater than the second preset threshold, the client of the first virtual character 1302 determines that the first virtual character 1302 does not need the target virtual object 1304 and triggers the automatic sharing function, to share the location information 1308 of the target virtual object with the second virtual object 1306 in the same camp.

In a possible implementation, in this embodiment, it may be, but is not limited to, that the time threshold is preset after the distance between the first virtual character and the virtual object is less than the first preset threshold. When the first virtual character does not interact with the virtual object after the first virtual character exceeds the preset time threshold, it is determined that the first virtual character does not need the virtual object, and the automatic interaction function (for example, the automatic sharing function can be triggered) is triggered, and the location information of this virtual object is shared with the second virtual object in the same camp.

This embodiment improves accuracy of the automatic sharing function by combining duration and a distance to determine whether to trigger the automatic interaction function, and combining different dimensions of time and space to determine whether to share the target virtual object with the second virtual character.

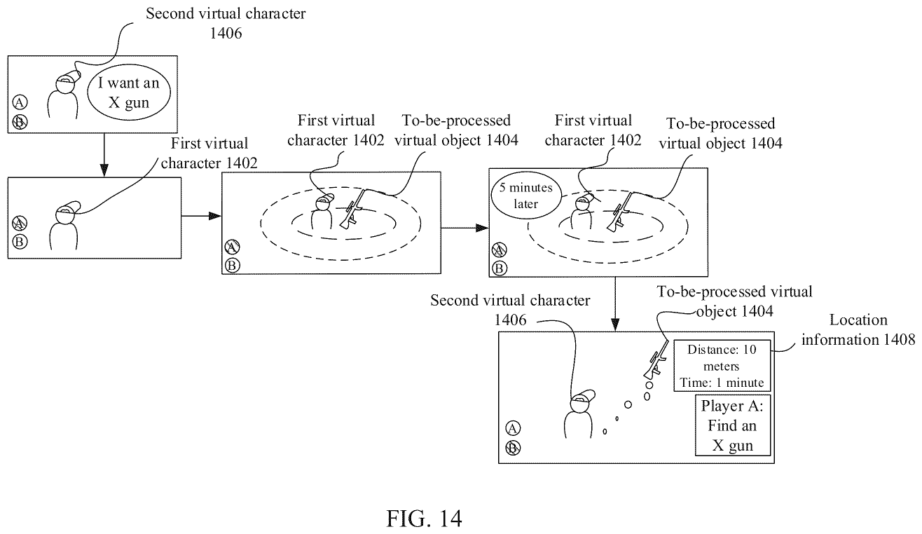

To further describe, for example, an example in which the interaction function is a sharing function, and the second virtual character interacting with the target virtual object to obtain the target virtual object for the second virtual character is used. For example, as shown in FIG. 14, the second virtual character 1406 transmits demand information “I want an X gun” to the client of the first virtual character 1402. When a distance between the first virtual character 1402 and the target virtual object 1404 is less than the first preset threshold, the client of the first virtual character 1402 waits for the first virtual character 1402 to obtain the target virtual object 1404. When the first virtual character 1402 still does not pick up the target virtual object 1404 when the preset time threshold is exceeded, the client of the first virtual character 1402 determines that the first virtual character 1402 does not need the target virtual object 1404 and triggers the automatic sharing function, to share the location information 1408 of the target virtual object with the second virtual object 1406 in the same camp.

According to the embodiments of this application, the target virtual object from at least one virtual object is determined if a distance between the first virtual character and the at least one virtual object in the virtual scene is less than or equal to a first preset threshold. When the distance between the first virtual character and the target virtual object is greater than the second preset threshold, it is determined that the automatic interaction function is triggered, to add a triggering condition for the automatic interaction function, thereby achieving the technical effect of improving the integrity of an automatic interaction application in different situations.

As an exemplary solution, the determining the target virtual object from at least one virtual object includes:

S1: Obtain an object priority of each virtual object in the at least one virtual object.

S2: Determine, from the at least one virtual object, a rare virtual object with an object priority greater than or equal to a rare threshold.

S3: Determine the rare virtual object as the target virtual object.

In a possible implementation, in this embodiment, the rare virtual object may be, but is not limited to, a virtual item with higher rarity preset by the player or a developer. The rare virtual object may be, but is not limited to, setting a priority of a high-level rare object as 0, a priority of a rare object as 1, and a priority of a normal object as 2.

In a possible implementation, in this embodiment, usage, a durability value, and a skin level of the virtual object can be used, but are not limited to, as the basis for determining the rare virtual object, to enhance the beneficial effect of improving accuracy and comprehensiveness of determining the rare object.

This embodiment takes into account a problem that a new player in the game do not know the rare virtual object in the game, and it is easy to miss the sharing of locations of some rare virtual objects. The embodiments of this application improve usage of the rare virtual object and a fault tolerance rate of the game by automatically and synchronously sharing the rare virtual object to the second virtual character.

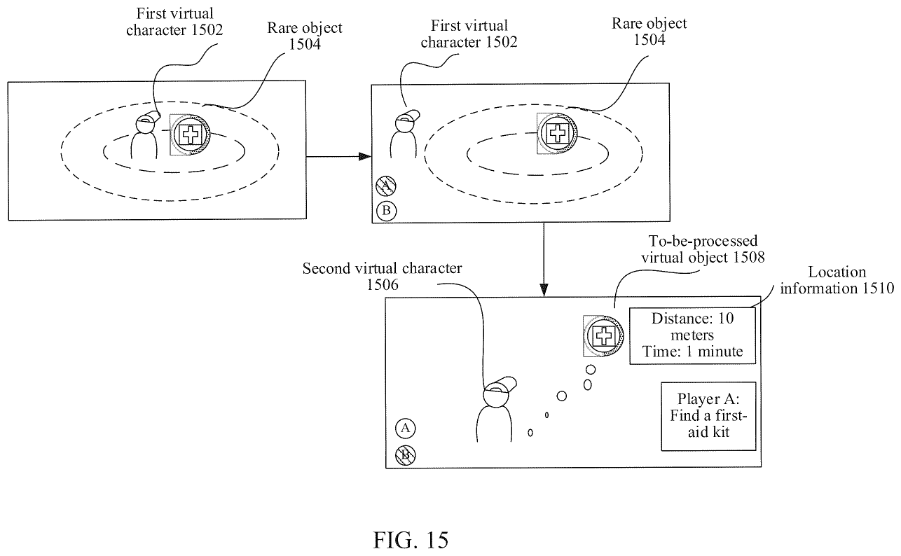

To further describe, for example, as shown in FIG. 15, the first virtual character 1502 approaches a pre-configured rare object 1504 and collides with a collider of the rare object 1504. When the first virtual character 1502 is far away from the rare object 1504, it is determined that the first virtual character 1502 does not need the rare object 1504. By further combining an item priority and a durability value, it is detected that the second virtual character 1506 does not own the foregoing rare object 1504 and does not own a higher-level rare object. Because a priority of a large first-aid kit is 0, and the second virtual character only owns a bandage, in addition, the priority does not own medical props such as the large first-aid kit and energy drinks, it is determined that the rare object 1504 is determined as the target virtual object 1508, and location information 1510 is shared with a client of the second virtual character 1506.

According to the embodiments of this application, an object priority of each virtual object in the at least one virtual object is obtained. A rare virtual object with an object priority greater than or equal to a rare threshold is determined from the at least one virtual object. The rare virtual object is determined as the target virtual object, to automatically and synchronously share the rare virtual object with the second virtual character, thereby achieving the technical effect of improving a fault tolerance rate of a game and improving interaction efficiency of a player.

In the embodiments of this application, there may be a plurality of control operations, therefore, there are a plurality of manners to trigger the automatic sharing function through the control operation for the first virtual character. As an exemplary solution, the triggering, through the control operation, an interaction function corresponding to a target virtual object of the virtual scene includes:

S1: Control, through the control operation, the first virtual character to move in the virtual scene.

S2: Trigger the interaction function if a distance between the moved first virtual character and the target virtual object is less than or equal to a preset distance threshold.

In a possible implementation, in this embodiment, a preset distance threshold can be set according to an actual situation. When the distance between the first virtual character and the target virtual object is less than or equal to the preset distance threshold, that is, when the first virtual character is close to the target virtual object, the interaction function is directly and automatically triggered.

According to the embodiments of this application, the interaction function is triggered if a distance between the moved first virtual character and the target virtual object is less than or equal to a preset distance threshold, to automatically trigger a prompt when approaching the virtual object, thereby achieving the technical effect of improving obtaining efficiency of the virtual object.

As an exemplary solution, the triggering, through the control operation, an interaction function corresponding to a target virtual object of the virtual scene includes:

triggering the interaction function if the first virtual character is controlled to perform a discard operation on the owned target virtual object.

In a possible implementation, in this embodiment, the control operation may be an operation of controlling the first virtual character to perform a discard operation on the owned target virtual object. The discard operation may be, but is not limited to, triggering the interaction function after discarding the virtual object already owned by the first virtual character. In this case, the virtual object discarded by the first virtual character can be determined as the target virtual object, and the location information of the target virtual object can be shared with the second virtual character.

In a possible implementation, in this embodiment, it may be, but is not limited to, that the interaction function may be triggered after the death of the first virtual character, the virtual object owned by the first virtual character before the death is determined as the target virtual object, and corresponding location information is displayed in the client of the second virtual character.

In a plurality of shooting games, a virtual character only has one chance to survive. When a game character dies, other virtual characters in the same camp can use the automatic interaction function to arrive at a death location of the virtual character in the same camp, inherit a virtual object of the dead virtual character in the same camp, to improve use efficiency of the virtual object, and improve passing efficiency between teammates.

According to the embodiments of this application, if the first virtual character is controlled to perform the discard operation on the owned target virtual object, it is determined that the automatic interaction function is triggered, to maximize the use of the virtual object, thereby achieving the technical effect of improving a utilization rate and obtaining efficiency of the virtual object.

As an exemplary solution, the triggering, through the control operation, an interaction function corresponding to a target virtual object of the virtual scene includes:

triggering the interaction function if the first virtual character is controlled to perform a discard operation on the owned virtual object, and a distance between the first virtual character and the owned virtual object is controlled to be greater than a third preset threshold.

To further describe, for example, when the first virtual character A obtains a higher-level virtual object, the owned lower-level virtual object of the same type is discarded, that is, a level 2 vest is discarded. When a distance from the level 2 vest is greater than the second preset threshold, and the second virtual character B does not own the level 2 vest and a level 3 vest, the interaction function is triggered, to determine the level 2 vest as the target virtual object, and display the location information of the level 2 vest in the client of the second virtual character.

Through the embodiments provided in this application, if the first virtual character is controlled to perform a discard operation on the owned virtual object, and the distance between the controlled first virtual character and the owned virtual object is greater than the third preset threshold, the interaction function is triggered. Furthermore, in a scene that the virtual object is not picked up or is picked up and then discarded, the foregoing virtual object is determined to be the target virtual object, and efficiency of interacting with the virtual object is further improved in consideration of various scenes. This achieves the technical effect of improving the completeness of achieving the automatic interaction function.

As an exemplary solution, after the displaying object prompting information, the method further includes:

hiding the object prompting information if the second virtual character interacts with the first virtual object, the first virtual object including the target virtual object or a second virtual object, similarity between an object type of the second virtual object and an object type of the target virtual object being greater than or equal to a fourth preset threshold, and an object priority of the second virtual object being greater than or equal to an object priority of the target virtual object.

In a possible implementation, in this embodiment, similarity between priorities of virtual objects of the same type may be, but is not limited to, displayed in the client of the second virtual object according to the priorities of the virtual objects. For example, the level 3 helmet is the target virtual object with a highest priority among the virtual objects, therefore, the level 3 helmet is displayed in the client of the second virtual character first.

When there are a plurality of target virtual objects, to avoid the problem that the object prompting information is prone to being redundant, causing the second virtual character to spend time and energy to determine useful object prompting information, this embodiment sets different priorities and hides the object prompting information of virtual objects of the same type with low priorities, thereby overcoming the problem of cluttered display of more prompting information, and improving prompting efficiency of the prompting information and obtaining efficiency of the virtual character.

According to the embodiments of this application, the object prompting information is hidden if the second virtual character interacts with the first virtual object. The first virtual object includes the target virtual object or a second virtual object. Similarity between an object type of the second virtual object and an object type of the target virtual object is greater than or equal to a fourth preset threshold, and an object priority of the second virtual object is greater than or equal to an object priority of the target virtual object, to further process according to priorities in the case of a same prop type, thereby achieving the technical effect of improving display efficiency of the object prompting information.

As an exemplary solution, the displaying object prompting information includes:

displaying the object prompting information when the interaction function is triggered, and the second virtual character does not interact with the first virtual object.

In a possible implementation, in this embodiment, a required item retrieval pool may be preset, but is not limited to. The required item retrieval pool may include, but is not limited to, virtual objects pre-configured by the second virtual character and virtual objects with high rarity, and the like. When the virtual object in the required item retrieval pool is obtained or the second virtual object obtains a virtual object with a high rarity, the virtual object is removed from the required item retrieval pool.

Through the embodiments provided in this application, when the interaction function is triggered and the second virtual character does not interact with the first virtual object, the object prompting information is displayed, to reduce the redundancy of the object prompting information, thereby achieving the technical effect of improving the display efficiency of the object prompting information.

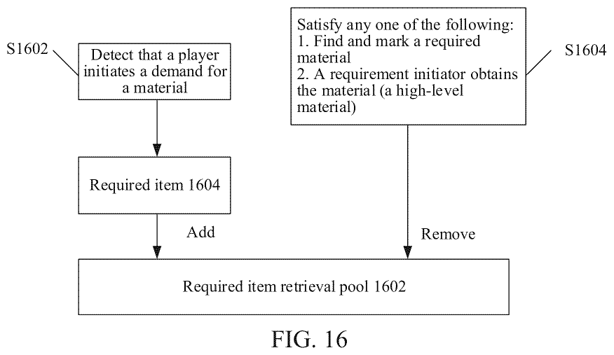

As an exemplary solution, the information prompting method is applied to a virtual shooting game scene. An example in which the interaction function is a sharing function, and the second virtual character interacts with the target virtual object to obtain the target virtual object for the second virtual character is used, as shown in FIG. 16, the specific operations are as follows:

S1602: Detect that a player initiates a demand for a material.

When the player transmits a request for the material through a detectable manner provided in the game, a system adds a requested item 1604 to the required item retrieval pool 1602. The detectable manner refers to common material request instructions, for example, each instruction corresponds to a specific item. The detectable manner may also refer to using other technologies to identify whether text information and voice information transmitted by the player are requests for materials. As mentioned above, the manner that the player initiates a request for a material is not limited in this patent.

S1604: Find and mark the requested material when the information added to the required item retrieval pool is satisfied, or remove the information after a request initiator obtains any condition for the material (a high-level material), or remove the originally requested information from the retrieval pool when the player picks up the required material or a better material (according to game settings). Because there is no need to retrieve an outdated requirement at this time.

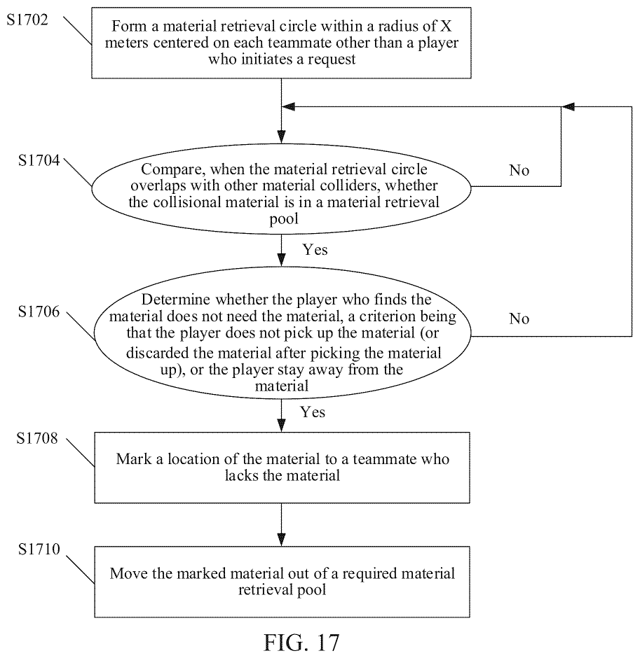

As shown in FIG. 17, the specific operations are as follows:

S1702: Form a material retrieval circle within a radius of X meters centered on each teammate other than the player who initiates the request.

In this technical logic, each player is treated as a movable material retrieval circle with an effective radius of X meters. It is the equivalent of a player character model moving around a coverage map in the game to look for materials. A distance is set to make sensitivity of determining the materials closer to actually walking to and finding the materials.

S1704: Compare, when the material retrieval circle overlaps with other material colliders, whether the collisional material is in the material retrieval pool.

During actions of each player, if the character passes through the material in the virtual scene (the passage may refer to a virtual collider of the material coincides with a collider of the material retrieval circle with a radius of X meters centered on the player), a program determines whether a player initiates a demand for the material, specifically by comparing whether the same material exists in the required material retrieval pool. If yes, perform the next operation. If not, continue to retrieve materials in other virtual scenes that cause collision.

S1706: Determine whether the player who finds the material does not need the material, a criterion being that the player does not pick up the material (or discarded the material after picking the material up), or the player staying away from the material.

After it is confirmed that a player needs the material, it is needed to wait for the finder to stop picking up the material and stay away from the material. The function of this operation is to avoid that the required material that is found is exactly what the finder needs. The program determining logic for this is that the found material is not picked up, or is picked up and then thrown back into the virtual scene, and the finder stays away from the material. Colliders between the two stops contacting, which means that the finder does not need this content and enters the next operation.

S1708: Mark a location of the material to a teammate who lacks the material.

S1710: Move the marked material out of the required material retrieval pool.

Through the foregoing S1702 to S1710, a search process for a material requirement is completed.

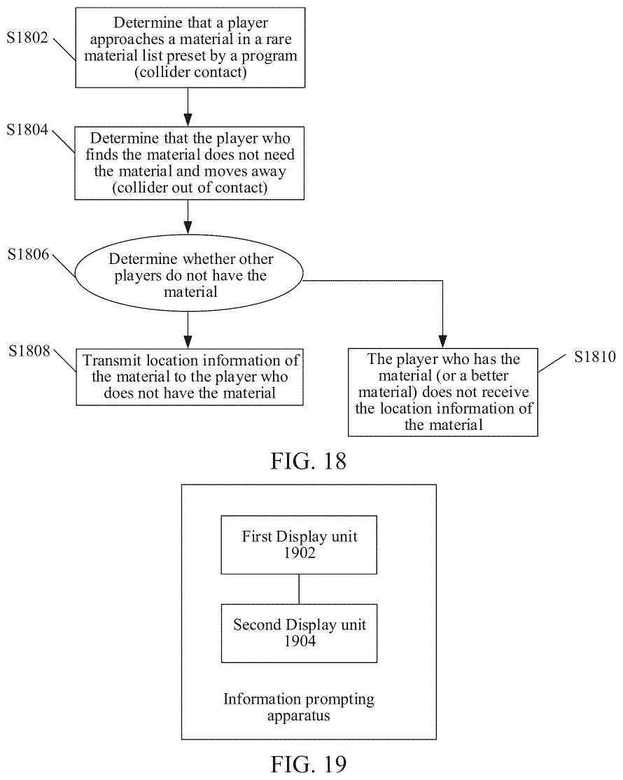

As shown in FIG. 18, the specific operations are as follows:

S1802: A player approaches a material in a rare material list preset by the program.

In the embodiments of this application, a manner to determine that the player approaches the material in the rare material list preset by the program may be that the player makes contact with a collider of an object (that is, collider contact). The rare material list is an information database with a series of advanced props defined by a game designer, and is used in the background to identify a material that collides with the player.

S1804: Determine that the player who finds the material does not need the material.

The manner to determine that the player who finds the material does not need the material may be a manner of disengaging the collider, that is, a character model of the player who finds the material stays away from the material, and a character model and a collider of the rare material are out of contact, then it is determined that the finder does not need the material and enters the next operation.

S1806: Determine whether other players do not have the material.

The program detects whether props and materials owned by other players include the foregoing found materials, or there are better materials. An implementation logic of the operation sets priorities for materials, such as a high-level rare material is set as 0, a rare material is set as 1, and an ordinary material is set as 2. It is determined, by comparing priorities of a same type of materials, whether there are better props. It is determined, by comparing whether there are the type of materials, whether there is lack. In addition to material levels, values such as usage/durability value of a material can also be used as reference indexes for comparison.

S1808: Transmit the location information of the material to the player who does not have the material.

For the player who does not have the material, it can be determined that the player may need the material, and the location information of the material can be transmitted to the player.

S1810: The player who owns the material (or a better material) does not receive the location information of the material.

No operation is performed for the player who owns the material or have a high-level material, so that the player who owns the material (or a better material) does not receive the location information of the material.

In the specific implementation of this application, relevant data such as user information is involved. When the foregoing embodiments of this application are applied to a specific product or technology, a permission or consent of a user is required, and collection, use, and processing of the relevant data need to comply with relevant laws, regulations, and standards of relevant countries and regions.

To simplify the description, the foregoing method embodiments are described as a series of action combination. However, a person skilled in the art is to be know that this application is not limited to any described sequence of the action, because some operations can adopt other sequences or can be executed simultaneously according to this application. In addition, a person skilled in the art also knows that all the embodiments described in the specification are exemplary embodiments, and the related actions and modules are not necessarily required by this application.

According to another aspect of the embodiments of this application, an information prompting apparatus for performing the information prompting method is further provided. As shown in FIG. 19, the apparatus includes:

a first display unit 1902, configured to display at least a part of a virtual scene, the virtual scene including a first virtual character and a second virtual character;

a second display unit 1904, configured to: receive a control operation for the first virtual character; trigger, through the control operation, an interaction function corresponding to a target virtual object of the virtual scene; and generate object prompting information in response to the interaction function, the object prompting information being configured for prompting the second virtual character to interact with the target virtual object.

For specific embodiments, reference may be made to the example shown in the foregoing information prompting apparatus. This is not described again in this example.

As an exemplary solution, the foregoing second display unit 1904 is further configured to display, after generating the object prompting information in response to the interaction function, the object prompting information.

As an exemplary solution, the foregoing second display unit 1904 includes:

a first display module, configured to display location information of the target virtual object in the virtual scene, the location information of the target virtual object in the virtual scene being the object prompting information.

For specific embodiments, reference may be made to the example shown in the foregoing information prompting method. This is not described again in this example.

As an option solution, the foregoing first display module is configured to display, on a client corresponding to the second virtual character, the location information of the target virtual object in the virtual scene.

As an exemplary solution, the foregoing first display module includes at least one of the following:

S1: A first display sub-module is configured to mark and display, on a mini map interface, the location information of the target virtual object in the virtual scene if the client corresponding to the second virtual character displays the mini map interface. The mini map interface is configured for thumbnail displaying scene content of the virtual scene.

S2: A second display sub-module is configured to display guidance information in a viewing angle picture if the client corresponding to the second virtual character displays the viewing angle picture corresponding to the second virtual character. The guidance information being configured for guiding the second virtual character to move to a location of the target virtual object in the virtual scene.

S3: A third display sub-module is configured to: if the client corresponding to the second virtual character displays the viewing angle picture, and the viewing angle picture displays the target virtual object, display, in the viewing angle picture, a prompting identifier corresponding to the target virtual object. The prompting identifier is configured for prompting a location of the target virtual object.

For specific embodiments, reference may be made to the example shown in the foregoing information prompting method. This is not described again in this example.

As an exemplary solution, the apparatus further includes:

S1: A third display unit is configured to display, before displaying the object prompting information, virtual identifiers of candidate virtual objects in a plurality of candidate virtual objects.

S2: A first determining unit is configured to determine, before displaying the object prompting information, a target virtual identifier from the virtual identifiers of the candidate virtual objects.

S3: A second determining unit is configured to determine, before displaying the object prompting information, a candidate virtual object corresponding to the target virtual identifier as the target virtual object.

For specific embodiments, reference may be made to the example shown in the foregoing information prompting method. This is not described again in this example.

As an exemplary solution, the foregoing third display unit includes at least one of the following:

S1: A second display module is configured to display a virtual identifier corresponding to a virtual object not interacted with the second virtual character, each candidate virtual object including the non-interacted virtual object.

S2: A third display module is configured to display a virtual identifier corresponding to a to-be-processed attachment object, the to-be-processed attachment object being an attachment object that is not configured by a virtual primary object interacted with the second virtual character, and the candidate virtual object including the to-be-processed attachment object.

S3: A fourth display module is configured to display a virtual identifier corresponding to a virtual object that the second virtual character allows to interact with, the candidate virtual object including the virtual object that allows to interact with.

S4: A fifth display module is configured to display a virtual identifier corresponding to a virtual object pre-configured for the second virtual character, the candidate virtual object including the virtual object pre-configured for the second virtual character.

For specific embodiments, reference may be made to the example shown in the foregoing information prompting method. This is not described again in this example.

As an exemplary solution, the apparatus further includes at least one of the following:

S1: A fourth display unit is configured to display, before displaying the object prompting information, first text information, the first text information including object text information corresponding to a first candidate virtual object in the plurality of candidate virtual objects; and determine the first candidate virtual object as the target virtual object if the first text information indicates that the second virtual character interacts with the first candidate virtual object.

S2: A first recognizing unit is configured to perform, before displaying the object prompting information and when to-be-processed audio is obtained, audio recognition on the to-be-processed audio to obtain second text information, the second text information including object text information corresponding to a second candidate virtual object in the plurality of candidate virtual objects; and determine the second candidate virtual object as the target virtual object if the second text information indicates that the second virtual character interacts with the second candidate virtual object.

For specific embodiments, reference may be made to the example shown in the foregoing information prompting method. This is not described again in this example.

As an exemplary solution, the apparatus further includes:

S1: A third determining unit is configured to, after displaying at least a part of the virtual scene, determine the target virtual object from at least one virtual object if a distance between the first virtual character and the at least one virtual object in the virtual scene is less than or equal to a first preset threshold.

S2: A fourth determining unit is configured to control, through the control operation, the first virtual character to move in the virtual scene; and trigger the interaction function if a distance between the moved first virtual character and the target virtual object is greater than a second preset threshold, the second preset threshold being greater than or equal to the first preset threshold.

For specific embodiments, reference may be made to the example shown in the foregoing information prompting method. This is not described again in this example.

As an exemplary solution, the foregoing third determining unit includes:

S1: A first obtaining module is configured to obtain an object priority of each virtual object in the at least one virtual object.

S2: A second determining module is configured to determine, from the at least one virtual object, a rare virtual object with an object priority greater than or equal to a rare threshold.

S3: A third determining module is configured to determine the rare virtual object as the target virtual object.

For specific embodiments, reference may be made to the example shown in the foregoing information prompting method. This is not described again in this example.

As an exemplary solution, the foregoing apparatus further includes:

a fifth determining unit, configured to control, through the control operation, the first virtual character to move in the virtual scene; and trigger the interaction function if a distance between the moved first virtual character and the target virtual object is less than or equal to a preset distance threshold.

For specific embodiments, reference may be made to the example shown in the foregoing information prompting method. This is not described again in this example.

As an exemplary solution, the apparatus further includes:

a sixth determining unit, configured to trigger the interaction function if the first virtual character is controlled to perform a discard operation on the owned target virtual object.

For specific embodiments, reference may be made to the example shown in the foregoing information prompting method. This is not described again in this example.

As an exemplary solution, the apparatus further includes:

a seventh determining unit, configured to trigger the interaction function if the first virtual character is controlled to perform a discard operation on the owned virtual object, and a distance between the first virtual character and the owned virtual object is controlled to be greater than a third preset threshold.

For specific embodiments, reference may be made to the example shown in the foregoing information prompting method. This is not described again in this example.

As an exemplary solution, the apparatus further includes:

a first hiding unit, configured to hide, after displaying the object prompting information, the object prompting information if the second virtual character interacts with the first virtual object, the first virtual object including the target virtual object or a second virtual object, similarity between an object type of the second virtual object and an object type of the target virtual object being greater than or equal to a fourth preset threshold, and an object priority of the second virtual object being greater than or equal to an object priority of the target virtual object.

For specific embodiments, reference may be made to the example shown in the foregoing information prompting method. This is not described again in this example.

As an exemplary solution, the first hiding unit includes:

a sixth display module, configured to display the object prompting information when the interaction function is triggered, and the second virtual character does not interact with the first virtual object.

For specific embodiments, reference may be made to the example shown in the foregoing information prompting method. This is not described again in this example.

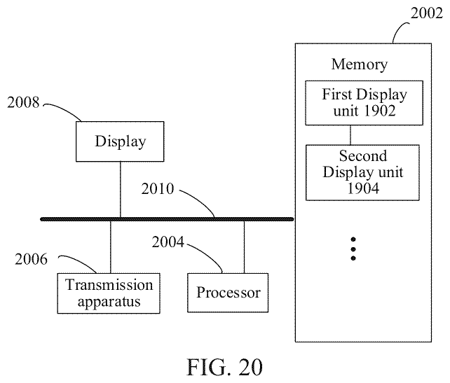

According to another aspect of the embodiments of this application, an electronic device configured to implement the foregoing information prompting method is further provided. As shown in FIG. 20, the electronic device includes a memory 2002 and a processor 2004. The memory 2002 has a computer program stored thereon, and the processor 2004 is configured to perform operations in any one of the foregoing method embodiments by using the computer program.

In a possible implementation, in this embodiment, the foregoing electronic device may be located in at least one of a plurality of network devices in a computer network.

In a possible implementation, in this embodiment, the foregoing processor can be configured to use the computer program to perform the following operations:

S1: Display at least a part of a virtual scene, the virtual scene including a first virtual character and a second virtual character.

S2: Receive a control operation for the first virtual character, and trigger, through the control operation, an interaction function corresponding to a target virtual object of the virtual scene.

S3: Generate object prompting information in response to the interaction function, the object prompting information being configured for prompting the second virtual character to interact with the target virtual object.

In a possible implementation, a person of ordinary skill in the art may understand that, the structure shown in FIG. 20 is only for example. The electronic device may be a smart phone (such as an Android mobile phone, or an iOS mobile phone), a tablet computer, a palmtop computer, a mobile Internet device (MID), a PAD, or the like. The structure of the foregoing electronic device is not limited in FIG. 20. For example, the electronic device may further include more or fewer components (for example, a network interface and the like) than those shown in FIG. 20, or has a configuration different from that shown in FIG. 20.

The memory 2002 may be configured to store a software program and a module, for example, a program instruction/module corresponding to the information prompting method and apparatus in the embodiments of this application, and the processor 2004 performs various functional applications and data processing by running the software program and the module stored in the memory 2002, that is, implements the foregoing information prompting method. The memory 2002 may include a high-speed random memory, and may also include a non-volatile memory, for example, one or more magnetic storage apparatuses, a flash memory, or another nonvolatile solid-state memory. In some embodiments, the memory 2002 may further include memories remotely disposed relative to the processor 2004, and the remote memories may be connected to a terminal over a network. Examples of the network include, but are not limited to, the Internet, an intranet, a local area network, a mobile communication network, and a combination thereof. The memory 2002 may be specifically, but is not limited to, configured to store information such as a moving distance, and object prompting information. As an example, as shown in FIG. 20, the memory 2002 may include, but is not limited to the first display unit 1902, and the second display unit 1904 in the foregoing information prompting apparatus. In addition, the memory 2002 may include, but is not limited to, other module units in the foregoing information prompting apparatus. This is not repeated in the example.

In a possible implementation, the foregoing transmission apparatus 2006 is configured to receive or transmit data over a network. Specific examples of the foregoing network may include a wired network and a wireless network. In an example, the transmission apparatus 2006 includes a network interface controller (NIC). The NIC may be connected to another network device and a router by using a network cable, to communicate with the Internet or a local area network. In an example, the transmission apparatus 2006 is a radio frequency (RF) module, which is configured to communicate with the Internet in a wireless manner.

In addition, the electronic device further includes: a display 2008, configured to display the information such as the moving distance, and the object prompting information; and a connection bus 2010, configured to connect each module component in the foregoing electronic device.

In another embodiment, the foregoing terminal device or server may be a node in a distributed system. The distributed system may be a blockchain system, the blockchain system may be a distributed system formed by connecting a plurality of nodes through network communication. A peer to peer (P2P) network may be formed between the nodes. Any form of a computing device, such as the server, the terminal, and another electronic device, may become a node in the blockchain system by joining the peer-to-peer network.

According to an aspect in this application, a computer program product is provided. The computer program product includes a computer program. The computer program includes program code configured for performing the method shown in the flowchart. In such an embodiment, the computer program may be downloaded and installed from a network through the communication part, and/or installed from the removable medium. When the computer program is executed by a central processing unit, the computer program executes functions provided in the embodiments of this application.

The serial numbers of the foregoing embodiments of this application are merely for description, and do not represent the merits of the embodiments.

The computer system of the electronic device shown is merely an example, and does not constitute any limitation on functions and use ranges of the embodiments of this application.

The computer system includes a central processing unit (CPU), which may perform various suitable actions and processing according to a program stored in a read-only memory (ROM) or a program loaded from a storage part into a random access memory (RAM). In the random access memory, various programs and data required by system operations are further stored. The central processing unit, the read-only memory, and the random access memory are connected to each other through a bus. An input/output (I/O) interface is also connected to the bus.

The following components are connected to the input/output interface: an input part including a keyboard, a mouse, or the like; an output part including a cathode ray tube (CRT), a liquid crystal display (LCD), a speaker, or the like; a storage part including a hard disk, or the like; and a communication part including a network interface card such as a local area network (LAN) card or a modem. The communication part performs communication processing over a network such as the Internet. A driver is also connected to the input/output interface as required. A removable medium, such as a magnetic disk, an optical disc, a magneto-optical disk, or a semiconductor memory, is installed on the driver as required, so that a computer program read from the removable medium is installed into the storage part as required.

Particularly, according to an embodiment of this application, the processes described in each method flowchart may be implemented as a computer software program. For example, this embodiment of this application includes a computer program product, the computer program product includes a computer program carried on a computer-readable medium, and the computer program includes program code configured for performing the methods shown in the flowcharts. In such an embodiment, the computer program may be downloaded and installed from a network through the communication part, and/or installed from the removable medium. When the computer program is executed by the central processing unit, the various functions defined in the system of this application are executed.

According to an aspect of this application, a non-transitory computer-readable storage medium is provided. The processor of the computer device reads the computer program from the computer-readable storage medium. The processor executes the computer program so that the electronic device executes the method provided in the foregoing optional implementations.

In a possible implementation, in this embodiment, a person of ordinary skill in the art may understand that, all or some operations in the methods of the foregoing embodiments may be performed by a program instructing hardware of the terminal device. The program may be stored in a computer-readable storage medium. The storage medium may include: a flash drive, a read-only Memory (ROM), a random access memory (RAM), a magnetic disk, an optical disc, and the like.

The serial numbers of the foregoing embodiments of this application are merely for description, and do not represent the merits of the embodiments.

When the integrated unit in the foregoing embodiments is implemented in a form of a software functional unit and sold or used as an independent product, the integrated unit may be stored in the foregoing computer-readable storage medium. Based on such an understanding, the technical solutions of this application essentially, or the part contributing to the related art, or all or some of the technical solutions may be implemented in a form of a software product. The computer software product is stored in a storage medium and includes several instructions for instructing one or more computer devices (which may be a personal computer, a server, a network device, or the like) to perform all or some of the operations of the methods described in the embodiments of this application.

In the foregoing embodiments of this application, the descriptions of the embodiments have respective focuses. For a part that is not described in detail in an embodiment, refer to related descriptions in other embodiments.

In the several embodiments provided in this application, the disclosed client may be implemented in another manner. The foregoing described apparatus embodiments are merely examples. For example, the division of the units is merely a logical function division, and may be other division manners during actual implementation. For example, a plurality of units or components may be combined, or may be integrated into another system, or some features may be omitted or not performed. In addition, the displayed or discussed couplings or direct couplings, or communication connections may be implemented by using some interfaces. The indirect couplings or communication connections between the units or modules may be implemented in electric or other forms.

The units described as separate parts may or may not be physically separate, and components displayed as units may or may not be physical units, that is, may be located in one place, or may be distributed on a plurality of network units. Some or all of the units may be selected according to actual needs to implement the solutions of the embodiments.

In addition, functional units in the embodiments of this application may be integrated into one processing unit, or each of the units may be physically separated, or two or more units may be integrated into one unit. The integrated unit may be implemented in the form of hardware, or may be implemented in a form of a software functional unit.

The foregoing descriptions are merely preferred embodiments of this application, and a person of ordinary skill in the art may make various improvements and refinements without departing from the spirit of this application. All such modifications and refinements are also to be considered as the protection scope of this application.

What is claimed is:

1. An information prompting method performed by an electronic device, the method comprising:
displaying a virtual scene, the virtual scene including a target virtual object, a first virtual character controlled by a first terminal and a second virtual character controlled by a second terminal;
receiving a control operation for the first virtual character when a distance between the first virtual character and the target virtual object is less than a first preset threshold;
in response to the control operation, triggering an interaction function corresponding to the target virtual object of the virtual scene; and
in response to the interaction function, transmitting object prompting information associated with the target virtual object to the second terminal, the object prompting information prompting the second virtual character to interact with the target virtual object.

2. The method according to claim 1, wherein the method further comprises:
causing a display of the object prompting information near the target virtual object in the virtual scene at the second terminal, the object prompting information including identity information of the target virtual object.

3. The method according to claim 2, wherein the method further comprises:
causing a display of an interaction result between the second virtual character and the target virtual object in the virtual scene at the first terminal.

4. The method according to claim 1, wherein the method further comprises:
displaying virtual identifiers of a plurality of candidate virtual objects;
determining a target virtual identifier from the virtual identifiers of the candidate virtual objects in accordance with the control operation for the first virtual character; and
determining a candidate virtual object corresponding to the target virtual identifier as the target virtual object.

5. The method according to claim 1, wherein the method further comprises at least one of the following:
causing a display of first text information at the first terminal, the first text information comprising object text information corresponding to a first candidate virtual object; and
determining the first candidate virtual object as the target virtual object when the first text information indicates that the second virtual character interacts with the first candidate virtual object.

6. The method according to claim 1, wherein the triggering an interaction function corresponding to the target virtual object of the virtual scene comprises:
controlling the first virtual character to move in the virtual scene; and
triggering the interaction function when a distance between the first virtual character and the target virtual object is greater than a second preset threshold, the second preset threshold being greater than or equal to the first preset threshold.

7. The method according to claim 1, wherein the method further comprises:
causing a removal of the object prompting information from the second terminal after the second virtual character interacts with a first virtual object, the first virtual object having an object type similar to an object type of the target virtual object.

8. An electronic device, comprising a memory and a processor, the memory having a computer program stored therein, and the processor being configured to perform an information prompting method including:
displaying a virtual scene, the virtual scene including a target virtual object, a first virtual character controlled by a first terminal and a second virtual character controlled by a second terminal;
receiving a control operation for the first virtual character when a distance between the first virtual character and the target virtual object is less than a first preset threshold;
in response to the control operation, triggering an interaction function corresponding to the target virtual object of the virtual scene; and
in response to the interaction function, transmitting object prompting information associated with the target virtual object to the second terminal, the object prompting information prompting the second virtual character to interact with the target virtual object.

9. The electronic device according to claim 8, wherein the method further comprises:
causing a display of the object prompting information near the target virtual object in the virtual scene at the second terminal, the object prompting information including identity information of the target virtual object.

10. The electronic device according to claim 9, wherein the method further comprises:
causing a display of an interaction result between the second virtual character and the target virtual object in the virtual scene at the first terminal.

11. The electronic device according to claim 8, wherein the method further comprises:
displaying virtual identifiers of a plurality of candidate virtual objects;
determining a target virtual identifier from the virtual identifiers of the candidate virtual objects in accordance with the control operation for the first virtual character; and
determining a candidate virtual object corresponding to the target virtual identifier as the target virtual object.

12. The electronic device according to claim 8, wherein the method further comprises at least one of the following:
causing a display of first text information at the first terminal, the first text information comprising object text information corresponding to a first candidate virtual object; and
determining the first candidate virtual object as the target virtual object when the first text information indicates that the second virtual character interacts with the first candidate virtual object.

13. The electronic device according to claim 8, wherein the triggering an interaction function corresponding to the target virtual object of the virtual scene comprises:
controlling the first virtual character to move in the virtual scene; and
triggering the interaction function when a distance between the first virtual character and the target virtual object is greater than a second preset threshold, the second preset threshold being greater than or equal to the first preset threshold.

14. The electronic device according to claim 8, wherein the method further comprises:
causing a removal of the object prompting information from the second terminal after the second virtual character interacts with a first virtual object, the first virtual object having an object type similar to an object type of the target virtual object.

15. A non-transitory computer-readable storage medium, having a computer program stored thereon, and the computer program, when run by an electronic device, causing the electronic device to perform an information prompting method including:
displaying a virtual scene, the virtual scene including a target virtual object, a first virtual character controlled by a first terminal and a second virtual character controlled by a second terminal;
receiving a control operation for the first virtual character when a distance between the first virtual character and the target virtual object is less than a first preset threshold;
in response to the control operation, triggering an interaction function corresponding to the target virtual object of the virtual scene; and
in response to the interaction function, transmitting object prompting information associated with the target virtual object to the second terminal, the object prompting information prompting the second virtual character to interact with the target virtual object.

16. The non-transitory computer-readable storage medium according to claim 15, wherein the method further comprises:
causing a display of the object prompting information near the target virtual object in the virtual scene at the second terminal, the object prompting information including identity information of the target virtual object.

17. The non-transitory computer-readable storage medium according to claim 16, wherein the method further comprises:
causing a display of an interaction result between the second virtual character and the target virtual object in the virtual scene at the first terminal.

18. The non-transitory computer-readable storage medium according to claim 15, wherein the method further comprises:
displaying virtual identifiers of a plurality of candidate virtual objects;
determining a target virtual identifier from the virtual identifiers of the candidate virtual objects in accordance with the control operation for the first virtual character; and
determining a candidate virtual object corresponding to the target virtual identifier as the target virtual object.

19. The non-transitory computer-readable storage medium according to claim 15, wherein the triggering an interaction function corresponding to the target virtual object of the virtual scene comprises:
controlling the first virtual character to move in the virtual scene; and
triggering the interaction function when a distance between the first virtual character and the target virtual object is greater than a second preset threshold, the second preset threshold being greater than or equal to the first preset threshold.

20. The non-transitory computer-readable storage medium according to claim 15, wherein the method further comprises:
causing a removal of the object prompting information from the second terminal after the second virtual character interacts with a first virtual object, the first virtual object having an object type similar to an object type of the target virtual object.
